(19) United States
(12) Patent Application Publication
(10) Pub. No.: US 2017/0124892 A1
(43) Pub. Date: May 4, 2017

(54) DR. DANESHVAR'S LANGUAGE LEARNING PROGRAM AND METHODS

(71) Applicant: YOUSEF DANESHVAR, WEST BLOOMFIELD, MI (US)

(72) Inventor: YOUSEF DANESHVAR, WEST BLOOMFIELD, MI (US)

(21) Appl. No.: 14/929,409

(22) Filed: Nov. 1, 2015

(51) Int. Cl. G09B 5/06; G09B 19/06

(52) U.S. Cl. CPC G09B 5/065; G09B 19/06

(57) ABSTRACT

Learning new language reading it right and pronouncing it accurately is very important, particularly when it comes to an international language such as English. There are huge numbers of people who are not able to read and speak English; therefore they are not able to communicate with Western world and each other. Learning to understand a new language and pronounce it accurately is not easy. Thus, this applicant introduces a universal voice recognition system and a method which allows such learning process to happen with a reasonable ease. So that people of the world can communicate with each other easily and enjoy.

This is a non-provisional Application claiming the priority of the provisional application 62/073,926 with filling date of Oct. 31, 2015.

### THE BACKGROUND OF THIS INVENTION

Learning a new language is very important, particularly when it comes to an international language such as English. There are huge numbers of people who are not able to read and speak English; therefore they are not able to communicate with the Western world and its great advances. Even some people of different non-English speaking countries are not able to communicate with each other because they do not have a common language thus they need to learn the international language to communicate. However, learning a new language and more importantly pronouncing it well and understanding it when it is spoken by a native English speaking person is very difficult. For this reason, this applicant is introducing a new method which allows a new language to be learned in a practicable fashion and also to be able to understand and speak it with the properties that are common for the English speaking westerners. For this purpose, a method which allows a new language to be learned quickly and be spoken accurately with proper pronunciation is needed and this applicant believes he is introducing such a new method. This application also addresses some other language related problems and provides solutions.

### BRIEF EXPLANATION OF THIS INVENTION

In this method initially the applicant provided with the teaching material for the student to get familiar with the material which is going to be discussed. Then a teacher reads a lesson or a teaching material which the student is supposed to learn. This step may be provided either in alive for or preferably in a prerecorded system. So that the student watches and hears the teacher on a speaker, TV or a computerized monitor. Then the teacher would read and pronounce multiple words and they will be repeated by the teacher so that the student will learn them the way the teacher Does and also their meanings and pronunciations are provided in the way which the teacher pronounces. However, the applicant believes that in practice reading and pronunciation of a written object by a student who is unfamiliar with the new language does not happen easily. Since the voice producing system of individuals from different countries with the languages of there are different and perhaps they are noise producing parts, their tongs and the mouth changes over the years therefore overall the voice producing parts of the process person, as well as they are hearing and their brain parts do not allow a new way of speaking and pronunciations to be adopted easily with the way a new language is heard and understood and pronounced. Thus a student may read and pronounce new words and repeat and repeat them at his best without recognizing the problems and mistakes which he or she is repeating. Thus they would not turn to be able to understand and pronounce the new language right. However, in this new method, a special voice recognition system which the applicant calls it as a “Universal voice recognition system” will be utilized, which will hear what the student says and transforms it to a written format which can be seen in a computer monitor. By using this method, the written format from the student's pronunciation can be seen and recognized. If the student was able to pronounce the words and letters right the awards and letters will appear on the monitor screen right. For example when the students says “I like Apple” he or she will see on the monitor the print of “I like Apple” and he or she and others will recognize that the student was able to pronounce those words and letters reasonably accurately as the teacher had done and the gold has achieved. But importantly also the system allows that the student to be tested to verify that he or she has learned. Which can be found by the computerized system which then the teacher or the system would be able to check and verify. Thus the applicant believes by using this method learning a new language and testing them will be much easier, and the people of the world can communicate easily and will have a better relation. This this application also provides solutions for some other language related problems as well.

### THE BRIEF EXPLANATION OF THE FIGURES

FIG. 1. Shows schematically a computer system with its peripherals.

FIG. 2. Shows schematically the front view of a voice muffing unit for use with a head phone.

FIG. 3. Shows schematically the top view of the voice muffing unit shown in previous FIG. 2.

FIG. 4. Shows schematically the side view of a voice muffing unit shown in previous FIG. 3.

FIG. 4. Show a page of teaching material used with this unit.

FIG. 5. Shows another page of a teaching material for use with this unit.

FIG. 6. Shows an algorithm which shows how this program functions.

FIG. 7. Shows, similar figures of a cup, a pencil, a car, an apple, a table, and a cat, which have a number written under them to identify them.

FIG. 8. Shows, the algorithm which shows symbolically how this system functions.

### THE DETAILED EXPLANATION OF THE FIGURES

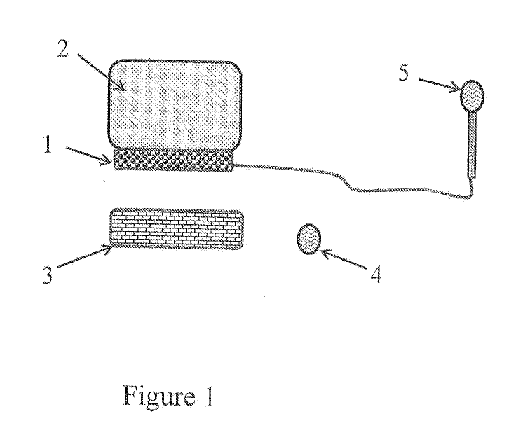

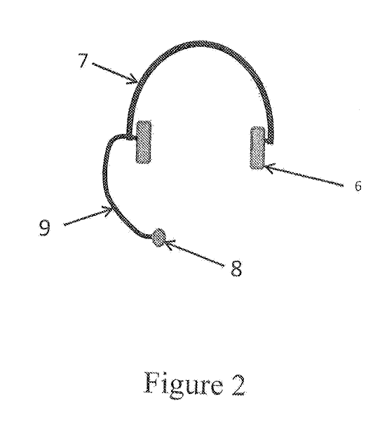

FIG. 1. Shows schematically a computer system consisting of a computer, shown at 1, a monitor, shown at 2, a keyboard shown at 3 and a mouse shown at number 4, Also a microphone 5. Which are electrically connected to each other. Importantly, the microphone and a headphone system shown at FIG. 2 may be used which has both microphone and a headphone. The microphone and headphone may be separated from each other in order to be used independently. So that microphone to be connected to computer for use with universal voice recognition system and headphone to allow to be used by the computer program or by another source of voice producing person, such as teacher, a recording tape, a video, the computer program or any other system.

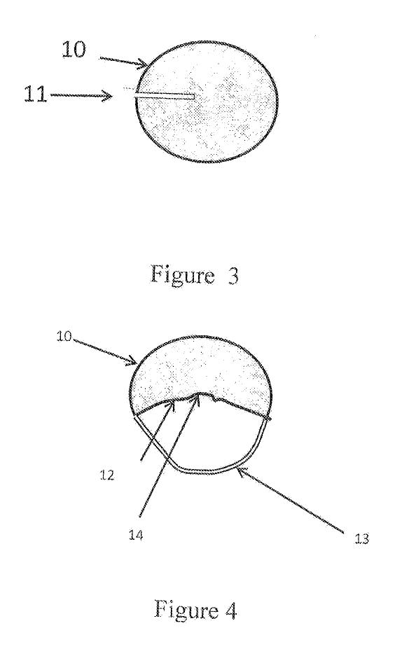

FIG. 2. Shows schematically a commonly used headphone and microphone for use in dictations and it consists of ear parts one shown at 6 which stand in front of the ears, for allowing the voice to be heard, an adjustable spring means, shown at 7 which holds the unit on the head and also has a microphone shown at a 8 and with an adjustable cable means shown at 9 which holds the microphone in front of the mouth of the user and is electronically connected to the computer system. This system will be attached to the computer systems by wires or a wireless system. Importantly the FIG. 3 shows a voice muffing system which the applicant has designed for covering the mouth and prevents the noise of the user from being transmitted to the ears of the other person sitting next to the first person.

FIG. 3. The shows schematically a mouth muff which was mentioned in previous FIG. 2 and is designed for being used for covering the mouth of the first person and prevents the noise from being transmitted from the mouth of the person speaking on that microphone to the ears of the 2^{nd} person sitting in proximity of the first person. This unit has a piece similar to a facemask, shown at 10, except this unit is designed for preventing from the noise to trans-pass. This unit will cover the front of the mouth and it has an outside cover similar to earmuff for holding a layer of voice absorbing material which will prevent the voice to trans-pass. The unit has a cut or an opening, which allows a cable means from the microphone shown at 9 at FIG. 2 to go through this cut, and allow the mouth muff to stand around the microphone shown at 8 in FIG. 2.

FIG. 4. Shows schematically the top view of the mouth muff explained in previous FIG. 3. This unit shows the cover shown at 10 which has a wide opening area, shown at 12, which stands in front of mouth and covers the mouth. An adjustable elastic band shown at number 13 allows this mask to be hold, in front of the mouth comfortably. Number 14, in this figure shows a shaped zone designed to sit on the area between the upper lip and lower nose area of the user. Note in these models. The nose of the person is not standing under the mouth muff. Which differentiate it from the face mask. Although, in some models the nose may be chosen to stay inside the mouth muff and receive the rear by designated tubing or openings.

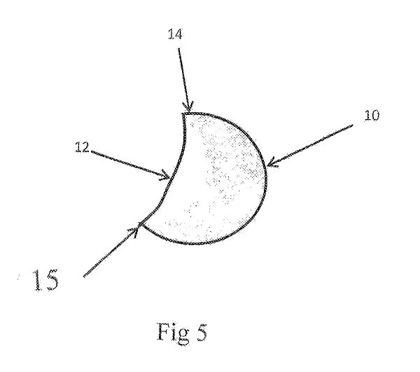

FIG. 5. Shows a schematically the side view of the mouth muff, shown in previous FIGS. 3 and 4 with its outside cover shown at 10 and an opening, shown at 12 which is designed to stand around the mouth of the user with its upper border shown at 14, which stands in the area between the upper lip and the lower nose and also it has the lower border 15 is designed to stands in the chin area. The surrounding borders of this unit is designed with having comfortable means such as soft sponges, rubbery materials or man-made covers which will make the borders of this unit a comfortable border, which stands around the mouth and allows the microphone to transmit the voice to the computer but to prevent from the noises the speaker from being transmitted outside of this mouth muff and have an wave energy to a degree to reach the ears of the next person sitting in the next kiosk and interfere with his performance.

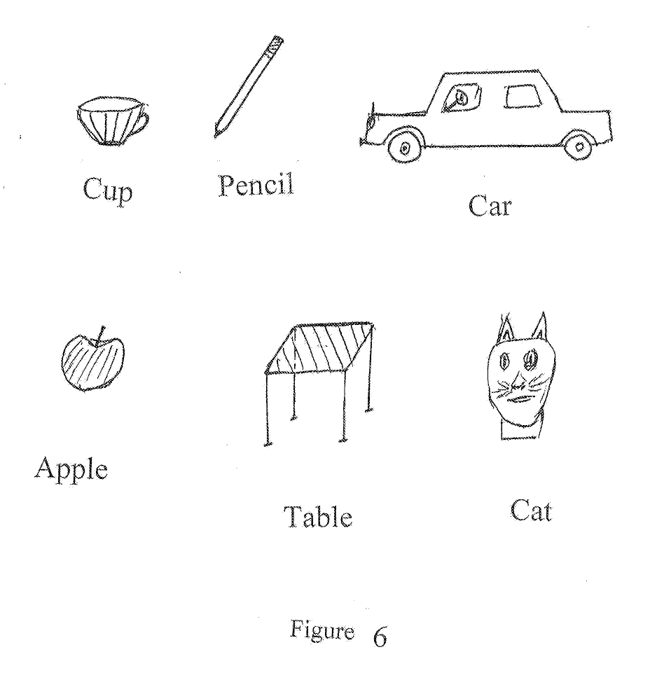

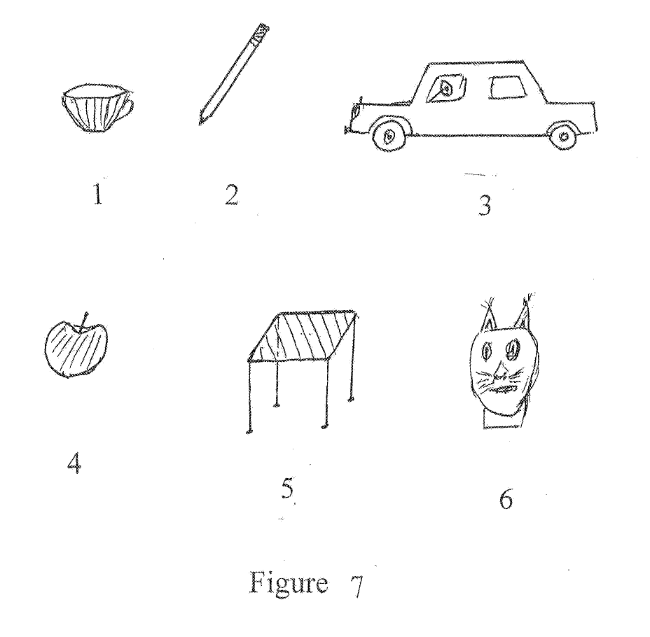

FIG. 6. Shows, a cup, a pencil, a car, an apple, a table, and a cat which have their name written under them. Or, the teacher may say “please open the page 4 and see of your hand book and look at the objects, marked from 1 to 6 and say those”. In this instance, the student has to open the page 21, and observe the page with having a cup marked at 1, pencil marked at 2, car marked at 3, chair marked at 4, table marked at 5 and cat marked at 6 as shown in FIG. 7. Then the student will say: Cup, pencil, car, apple, table and cat.

FIG. 7. Shows, similar figures of a cup, a pencil, a car, an apple, a table, and a cat, which have a number written under them to identify them.

Please note in this method, a system of using more than one monitor may be considered. For example the user may use one monitor for hearing and noting the directions and a second monitor for viewing the printed materials produced by the speech recognition system. Also note in practice in a classroom, a large TV or monitor may be used for viewing the information which the teacher will provide and he or she then asks the student to follow his/her directions and see the items marked on the large screen and say those. For example: the larger screen showing: Cup, pencil, car, apple, table, and cat. And then the student has to say: zzz

Cup, pencil, car, apple, table, and cat, to the special voice recognition system, which here on the applicant refers as the “universal voice recognition system UVRS” will type them individually in the smaller video monitor, which is for each student to see. So that the student will be able to recognize whether he or she was able to pronounce those words in the same fashion which the teacher has spoken. Please note proper engineering will be utilized in order to allow each student to use a kiosk, of his or her own so that the voices will not be transmitted from one student to the other student's microphone and the system can be functional. Also importantly, by using digital systems it may be possible to use single monitor showing both the:
A. What the teacher says and shows.
B. What the universal voice recognition system prints.

After the student has listened to the teacher or alike and spoken to the microphone one of two things happens:
A. The universal voice-recognition system prints on the monitor, the words spoken by the student properly as it should. This would be ideal and shows that the student has learned how to pronounce the teaching material properly.
B. The voice-recognition system shows on the monitor something different than what the student is supposed to say, for example, instead of typing “cat”, types “catch” this allows the student to recognize that he or she has not pronounced the word properly as the teacher has done. Therefore, he or she needs to try more and modify his or her voice and correct and improve his or her pronunciations, until it is perfect and the system accepts.
This unit, particularly when is used by individual and a prerecorded computerized system will allow:
I. The student to go back and forth with the teaching material and listen to what the teacher has said as many times as they want.
II. The student also will be able to take time and repeat the prerecorded materials as many times as he or she wants, so that finally he/she will be able to pronounce it the way he or she is supposed to.

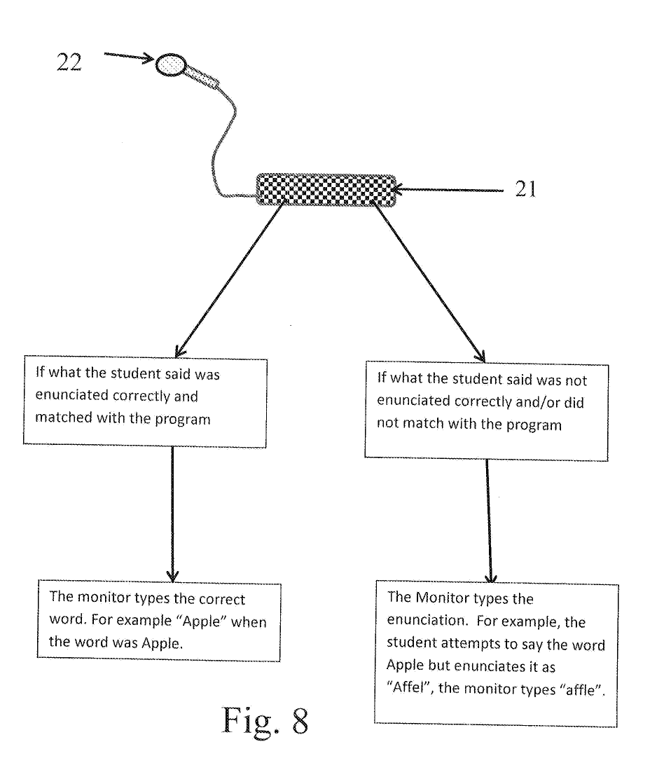

FIG. 8. Shows an algorithm which shows how this program functions. In this figure a computer system is enhanced with a special voice recognition system, as shown in 21 and explained in this application will be utilized. As shown 21 is connected to the microphone shown at 22. At the time of use the student will talk to the microphone 22 and the computer 21 will analyze the enunciation. Based on the program one of the following algorithms will be followed.
a) If what the student said was enunciated correctly and matched with the program, the monitor types the correct word. For example “Apple” when the word was Apple.
b) If what the student said was not enunciated correctly and/or did not match with the program, the monitor types the enunciation. For example, the student attempts to say the word Apple but enunciates it as “affel”, the monitor types “affle”.

Using this computer system and its peripherals shown in the above mentioned figures allow the headphone to be used, either attached to the computer system or to another source of voice producing system, such that the student can hear the voice of the teacher either in:

A. Live voice. A teacher in the room and talking to the students.

B. A pre-recorded voices, the teacher's voice to be heard from a recorder.

C. Teacher to be viewed from a monitor or TV, so that both his voice can be heard and also the motion and the movement of his mouth and tongue can be visualized in more details. So that the student can see and note how certain words are made by using the combinations of the lips, the tongue and the moving parts of the face of the teacher. Since this is very important in certain cases for example, English speaking people at times protrude their tongue and move it in a special way and moving the lips as well in order produce the word “the” these types of movements are very special for the student to see and learn in these teachings segments particularly during the recording. The movie camera will be skillfully directed to magnify the lips, tongue and the chin of the teacher in order to show the student how the teacher uses his/her complex voice producing system in order to pronounce special words in the same way which commonly the Americans do. Importantly, by using this method, all of such important words and pronunciations will be taught to the students in details so that by practice they will be prepared to use these words properly as the teacher does.

By using one of the above mentioned methods the voices will directs the student to hear a series of the commands which teacher gives and to follow what the teacher says. For example, the teacher may say: say the following words one after another: Cup, pencil, car, apple, table, and cat as shown in FIG. 6.

Explaining the Universal Voice Recognition System.

This is a voice recognition system which importantly, is designed, taught and modified by utilizing voice of a teacher who is capable of reading and pronouncing English in the way English speaking teacher do so that the voice-recognition system will have the voice of the teacher as the accurate model or the benchmark. Thus, by being engineered and modified this system will consider a similarly imitated voices of the teacher as equal and as same as the teacher and will print their voice exactly the same as the teacher's voice will print. This engineered voice-recognition system is referred here by the applicant as “The universal voice recognition system” which for the American English will be a model which is international and universal. So that for example if the teacher has said “Apple” it will print “Apple” in the monitor. Now if the student of the teacher also said “Apple” the same way as the teacher did, the monitor would type “Apple”. This is a very important and critical function of this system and it will allow this method to be functional and useful. This special function makes this system unique and very useful. Importantly, note the student either will read the words on a written format on paper or in a TV or monitor system. He or she then will listen to the pronunciation of the words by using a headphone so the student has the headphone and the system allows:
I. The student hears the words pronounced by the teacher or alike from the headphone.
II. Then he or she will have the chance to imitate the teacher and say what the teacher has said in his/her own microphone, imitating the teacher and repeating the words the same way as the teacher has done.
III. At this step the voice of the student will be transmitted by the microphone to the universal voice recognition system of the computer system. And the universal voice recognition system will create the written version of what it has heard from the microphone of the student on the screen.
IV. The student will see on the screen of his or her monitor the written format of what he or she has pronounced. This will allow the student to recognize if he or she was able to pronounce the words accurately. If not, he or she has to try again and again until he or she reaches the right pronunciation of the words as the teacher had done.

Importantly, a proper adjustment and calculations may be done by the computerized system to jump from the properly pronounced words to the next word after the student was able to pronounce a given word accurately. For example, if the student said cup, and the voice recognition system typed on the monitor “shop” which is wrong and has to be repeated, however when the student was able to say “cup” and saw the “cup” was printed on the screen, then the program will automatically proceed with showing the next ward “pencil”, and the same plan will be followed. This process may also relate with the repeating the same voice as long as it is not said/pronounced accurately or this function may be done by the student. So that a special key from the computer keyboard may be assigned to take this student back and forth, so that, with using the proper key from the keyboard this function will occur.

Also importantly, the program may have system which the student may be able to jump from one word to another from what the teacher has said. Or make the words to be repeated as they are said by the teacher.

Also importantly, the program may have a system which the student may be able to jump from one word which he has pronounced and is in the monitor to another.

The following methods will be utilized in teaching the students to learn and relate the words with the object, such as the following.

S1. The teaching objects may be shown in:
1. A printed format like a paper or a book.
2. On photos as a slide format, one photo, followed by the other.
3. On a video format, one subject followed by the other one.
4. On TV.
5. On computer screen format, like a slide or a video format.

So that per direction the student will see only the pictures of the objects and he or she has to pronounce the name of that object. For example, if in the book there is a picture of a cup the student has to pronounce “cup” and there will be no written name of this cup in the book and it would be the duty of the student to recognize and say the cup when the photo or picture of a cup is shown. Then picture of pencil will be shown and the student has to pronounce “pencil” and so on. Please note for a student many time it may not be possible to say the name for the photo which is shown for example a student may not know the name of the fire engine or tow truck but has to learn and associate the proper name with the photo or picture. Importantly, for use in blind people a real or small example of the material may be shown, such as a real cup, a pencil, and small car, an apple, a small table and a small cat, or may be provided in written format by using their special booklet which they would need another system since they would not be able to see the screen and they may hear the voice. For example touching the cat will create the voice of a cat and touching the cup with create the voice of a cup.

S2. In another version of the format of illustration, as explained earlier, the material not only will have the shape or the photo of the object like a cup and pencil, etc. but also it will have its written format as a “Cup”, a “Pencil” next to it. So that the student can correlate the shape of the cup with the written format of the cup as “Cup” as shown in FIG. 6 and hear the pronunciations.

S3. In the third format: The student will be provided with collections of various objects in a photo: such as, a cup, marked as number 1, a pencil marked as number 2, a car, marked as number 3, an apple marked as number 4, a table marked as number 5, and a Cat, marked as number 6. As shown in FIG. 7 and the student will be directed to pronounce each one of them in a succession for example; in this case the student is directed to say: Cup, pencil, car, Apple, table, and cat.

The applicant believes that using this method may be easier and cheaper. And the student will be directed to follow page by page of such illustrated materials and start reading them. Please note that in other format as shown in FIG. 6, the shape of the object may have subtitle and have its name printed as well. For example, as shown in part S2 the photos will have the photo of the cup and also the written word “cup” next to it or the shape of the pencil, with the written word “pencil” next to it, so on and so forth. So that the student will be able to correlate the shape, with the written format and also to proceed with its pronunciation as it is taught by the teacher and can be heard by use of the headphone. Then the student will see the written format to appear on the computer screen by use of the voice-recognition system.

Therefore, by doing so, the applicant believes the process of learning will be much more educational and easy, and the student can learn these processes in a shorter time. Most importantly, he or she will also be able to pronounce the words in the way that particular teacher is pronouncing in the way it should be pronounced accurately, thus a universal language of communication will be possible. Also using the computerized system allows the student to follow the course with his or her own pace.

Importantly, this system will also be modified to allow: translating from one language to another. For example, hearing number one in Chinese in the headphone and reading number one in English from a written material, and then seeing it to appear in the computer screen in English.

Or:

D1. Seeing the words in Chinese, such as a cup.

D2. Noting that word in English, written as “Cup”

D3. Hearing in the headphone or speaker as “Cup” pronounced in English.

D4. Pronouncing the cup the way it is heard from the teacher in the headphone or speaker.

D5. Watching the monitor to see the word “cup” to be printed by use of the universal voice-recognition system.

D6. If the print is similar to the “cup” it would be success and the student will go to the next word.

D7. If the print was not same as, “cup” then the student has to repeat the pronunciation, until he or she comes up with the right pronunciation and the process will be continued. Until he or she gets it right.

Translating from One Language to Another.

For example, hearing number one in English in the headphone and reading number one in Chinese and seeing it to appear in the computer screen. This is for allowing different languages by English-speaking people. For example, learning Chinese, German, French, and the Spaniol. Which can be done by using this method, and the applicant believes due to the efficiency of this system, it will allow the other languages to be learned much more easily, so that the communication can happen between different people with different languages as someone is interested.

Teaching Different Subjects and English for Different Specialties.

Importantly, the applicant promotes making courses for teaching of various specific subjects such as medicine, engineering, mathematics, law or politics, etc., Which they have their own common words, pronunciations and dialogs which are useful for one specialty only but does not have very much use for the others specialties. So that the student will learn the materials for the specialty, he or she is interested.

Teaching Various Programs as Well as English at the Same Time.

Also importantly, the applicant promotes making programs for teaching special programs such as accounting format, Excel from the words program, important directions of use and functions of the keys in word for program and other computer programs by electing that particular programs. So that, the student will learn both the English language and also in the process being able to learn how to use that particular program. So that the time of the student will be used in the best possible way.

Detailed Explanation of this Invention.

Learning new language is very important, particularly when it comes to an international language such as English. There are huge numbers of people who are not able to read and speak English and are not able to communicate with the western world and benefit from its great advances. Even many people of different non-English speaking countries are not able to communicate with each other because they do not have a common language thus it would be better for them to learn an international language for being able to communicate. However, learning a new language and more importantly understanding and pronouncing it properly is not easy. Therefore, learning how to speak English the same way which a good teacher of English does will be tremendously beneficial and advantageous. However, also, such learning is not easy and is very difficult but absolutely worth it. Since understanding and speaking English properly not only allows a good communication, but is part of prestige for many foreigners. If someone speaks English well in communication, the listeners will get the impression that the speaker is also great in many other subjects and the skills. Thus this applicant believes it would be a tremendous service helping the others to learn English properly, understand it easily and being able to pronounce it as the English speaking people do. Also, this will be true for other languages as well. Therefore, he is introducing a new method which allows a new language to be learned relatively easily in a practicable fashion and also making the learners to be able to understand and speak English with the properties and same fashion that are commonly used by the English speaking westerners. In this method, the intention is to allow a new language to be learned quickly, be understood and spoken accurately with proper pronunciations. This process by itself will also allow the person to understand the other who speaks English properly easily.

The way this method works is that initially a teacher reads a teaching material which the student is supposed to learn which can be done either alive or preferably in a prerecorded systems and the student watches and hears the teacher on a headphone, speaker, TV or monitor. Then multiple words will be read properly and repeated by the teacher so that the student will learn their meanings and pronunciations the same way which the teacher does. However, note that the applicant has learned that in practice understanding and pronunciations of a written object by a student unfamiliar with that language does not happen easily. Since the voice producing system of individuals from different countries with different languages are different and is not easy to understand the details and adopt a new language even by a good student. What happens is that with the present available methods a student reads and pronounces the new words in a different way than the teacher and repeats and repeats without recognizing the problems and mistakes which he or she is making. Although it is possible for a given student to have a teacher of his or her own to teach how to pronounce the words and correct the student, but this is an exception, is a very expensive way of doing this and achieving the results. Also it cannot be done in different hours, such as middle of the night or holidays. And it's not possible for a mass since there are not enough resources available for doing so. However, very importantly, in this method, a special voice recognition program will be utilized which will hear what the student says and transforms it to a written format that can be seen by the student in the monitor of a computer.

FIG. 8. Shows an algorithm which shows how this program functions. In this figure a computer system is enhanced with a special voice recognition system, as shown in 21 and explained in this application will be utilized. As shown 21 is connected to the microphone shown at 22. At the time of use the student will talk to the microphone 22 and the computer 21 will analyze the enunciation. Based on the program one of the following algorithms will be followed.
a) If what the student said was enunciated correctly and matched with the program, the monitor types the correct word. For example “Apple” when the word was Apple.
b) If what the student said was not enunciated correctly and/or did not match with the program, the monitor types the enunciation. For example, the student attempts to say the word Apple but enunciates it as “affel”, the monitor types “affle”.

Using this computer system and its peripherals shown in the above mentioned figures allow the headphone to be used, either attached to the computer system or to another source of voice producing system, such that the student can hear the voice of the teacher either in:

A. Live voice. A teacher standing in the room and talking to the students.

B. A pre-recorded voices, the teacher's voice to be heard from a recorder.

C. Teacher to be viewed from a monitor or TV, so that both his voice can be heard and also the motion and the movement of his mouth and tongue can be visualized in more details. So that the student can see and note how certain words are made by using the combinations of the lips, the tongue and the moving parts of the face of the teacher. Since this is very important in certain cases for example, English speaking people at times protrude their tongue and move it in a special way and moving the lips as well in order produce the word “the” these types of movements are very special for the student to see and learn in these teachings segments particularly during the recording. The movie camera will be skillfully directed to magnify the lips, tongue and the chin of the teacher in order to show the student how the teacher uses his/her complex voice producing system in order to pronounce special words in the same way which commonly the Americans do. Importantly, by using this method, all of such important words and pronunciations will be taught to the students in details so that by practice they will be prepared to use these words properly as the teacher does.

By using one of the above mentioned methods the voices will directs the student to hear a series of the commands which teacher gives and to follow what the teacher says. For example, the teacher may say: say the following words one after another: Cup, pencil, car, apple, table, and cat as shown in FIG. 6.

By using this method, the written format from the student's pronunciation using voice recognition system and the monitor should be the same or at times maybe very much the same as what the teacher has said. For example if the student says, “I like Apple”, the voice-recognition system should print on the screen of the computerized system “I like Apple”. And if this does not happen, for example it prints “I like Attel” the student will recognize the mistake and notes he or she has to pronounce the words again the way the teacher said. Therefore, it is very important and there is a critical issues which in this method the voice-recognition system to be already trained to recognize the voice of the given teacher whom his or her voice is being used as the benchmark. So that the student has to imitate the voice of the teacher to a degree to be similar to be accepted by the voice recognition system as similar. Reaching this goal will be an unbelievable advantage, since it means the student is capable of understanding and the speaking the same way as a good teacher do. Thus the people from various nationalities and languages will end up speaking English pretty much in the same way as the teacher does. This will be much easier if it is done when the student is very young and easily adoptable. Importantly, in some cases there could be subtitle in the language of the person who is learning. For example, if the language of the student is Farsi (Persian) the subtitles will be in Farsi (Persian) as well to help the student learn. Also importantly, in this method for the foreigners there will be a teaching material in their own language, which the student will hear and or see before hearing the English version of that teaching. What this will do is to prepare the student to recognize the meanings and the story behind the upcoming teaching material in English. Therefore, he or she will be prepared for understanding the English part.

Using Male Teachers to Teach the Males and Female Teachers to Teach the Females.

Importantly, note that with regard to the teachers and teaching the students, the applicant considers an important factor: which is using the male teachers for the Male students and the female teachers for the female students considering the fact that in practice, there is different ways, which the males speak versus the females. Naturally, the females speak in a more musical and the feminine fashion. However, the male's voice is different, and is less musical and has male tone. This has apparently due to the sex hormones, body structure of the make up the body of the males and females and needs to be respected as it is done in many ways. For example in the shopping's. There are men parts and the woman part. And the men parts, there are different under wears and nobody will see bikinis. But in the woman part, there are bras and skirts.

Using Children Programs by Children, for the Children.

Importantly, note that with regard to the teaching the children, the applicant considers using programs which are made by using children as the teacher for use by the children. Considering, that's it may attract more and teach more. Such programs will have their own attractions for the small children.

For understanding these methods also please note the figures and information provided in the figures. The main system which will be used in this method is shown in FIG. 1. This figure shows schematically a computer system consisting of a computer, shown at 1, a monitor, shown at 2, a keyboard, shown at 3, and a mouse shown at number 4, which are electrically connected to each other. Also a microphone, 5. FIG. 2 shows a headphone and explains its parts. This setup will allow a headphone to be used, either attached to the computer or to another source of voice, or both. So that the student can hear the voice of the teacher either in:

A. Live voice.

B. A pre-recorded voices.

Thus the student hears the teacher and his or her commands and follows what he or she says. For example, the teacher may say: say the followings one after another:

Cup, pencil, car, apple, table, and cat.

Or, the teacher may say open the page 21 of your hand book and look at the objects, marked from 1 to 6 and say those. In this instance, the student opens the page 21, of his or her booklet and observes the page which shows the page. Similar to the FIG. 7 of this application with having a cup marked at 1, pencil mark at 2, car marked at 3, apple marked at 4, table marked at 5 and cat marked at 6. Then the student will say:

Cup, pencil, car, apple, table and cat. In this method a system using more than one monitor also may be considered. Which, in the 2 monitor system, the user may use one monitor for hearing and noting the directions and the second monitor for viewing the printed materials in the monitor from the voice recognition system or for other purposes. Also note in practice in a classroom, a large TV-monitor may be used, so that the teacher will show the information and ask the students to follow his/her directions and see what he/she has marked on the large screen to be said. For example: the large TV or monitor will show:

Cup, pencil, car, apple, table, and cat. And then the student has to say:

Cup, pencil, car, apple, table, and cat. Please note proper engineering will be utilized in order to allow each student to use a kiosk and a communication system of his or her own so that the voices will not be transmitted from one student to the other student's microphone or ear, so that the system can be functional. For this purpose this applicant introduces means of preventing the voice being transmitted from one person to another by adding a unit which the applicant calls it “mouth muff” as shown in FIGS. 3, 4 and 5. This mouth muff is similar to a modified facemask so that it can be placed around a microphone and close the surrounding area of the mouth and voice producing system. This unit has a voice absorption layer inside so that it will prevent from transmission of the voice outside. Therefore allowing the microphone to stay inside and carry the voice while preventing the voice from being transmitted to the surrounding area. The use of such unit will allow in a classroom of 20 or 30 or more people to be possible. The teacher or the monitor will teach educational materials and the students to repeat them in their own microphone inside the mouth muff to see the voice recognition system to print individually in their own monitors. While the neighboring students also being able to do the same, without having problem with the voice of their neighbor students.

Teaching Proper Pronunciation of the Words and Common Languages.

Importantly, this applicant proposes this method of improving the language and pronunciations of some ethnic groups or group of people which they are talking English. However, their mother tongue is different with different pronunciations accents and dialogs making them not being able to get the proper positions and jobs because of their inability to talk English properly. For example, with a good intention in mind the applicant wants to consider the African Americans who live in America. The African Americans are born in the America and speak English, however, at times if another person hears their voice on the telephone, he or she will be able to say that the speaker in the other side of the phone is an African-American because they have a special accent and pronunciations of the words which are different than used by the white Americans. The applicant simply wishes to say that he personally is not against a group having accent, but he simply wants to point a problem which is happening in this society and African Americans and some other groups end up with using a language which is different than the whites. Also the applicant believes it will be beneficial for the African-Americans to be able to talk the same way as the white Americans do so that the others can understand them easily. If this happens, the applicant believes the chance of African-Americans for getting more jobs will be much higher. Because in the background there are questions that some of the African-Americans speak in a way that the others do not understand easily. Again, the applicant is bringing up this poignant, not because he wants to make African-Americans uncomfortable, but he is seeing this as a problem and suggests a solution. However, his intention is to use a method which will help the African-Americans and similar to get better jobs, better education and better social economic status. For this reason he provides the following:

Applicant believes that the African-American should be taught from childhood to speak the English properly as the white Americans commonly uses. For this reason he believes that the parents of an African-American child should consider this issue and one of the ways to reach this goal is by using courses introduced in the application such as:
A. Home-based teaching units.
B. School-based teaching methods.
C. Library based teaching methods.
D. Community-based teaching methods.
E. TV and movie based teaching methods.
F. And every other teaching methods that can be used in order to teach an African-American to be able to talk English, in the way which the majority of the American do, with proper pronunciation, and skills so that they be able to get a better job, better position and similar.

This can be also true about any other minority groups, different nationals which are living and speaking in a way which a person in the other side of the phone has difficulty understanding them. And the properties of their languages allow the audience of the phone being able to guess which ethnicity they are and misjudge them, because of their pronunciations and speaking Even though there is nothing wrong with different ethnicities of way of lives, but the issue is that at times it may prevent them from joining to the majority and the progress. Therefore, at times having an accent may make communications difficult and may decrease the chance of finding jobs and higher positions and similar. For this reason the applicant wishes to bring these teachings to certain people in order to give them a higher chance of equal opportunity similar to the white Americans. For this purpose teaching methods are suggested so that any child can use these teaching materials to:

B1: The person to listen to a pre-recorded information from a teacher who speaks that language properly.

B2. The student will repeat what the teacher says, until he or she is able to pronounce them properly.

B3. The student then speaks to the universal voice-recognition system, so that the universal voice recognition system will transform the voice of the student to the written format.

B4. The student will have the chance to recognize whether he or she was able to pronounce the words the same way as the teacher did if the written format on the monitor system was the same as it was intended to. For example: if the student says “That flower is beautiful”. The monitor should print “That flower is beautiful”. If this happened, it shows the success. But, if the monitor printed “that cover is beautiful”. Then the student will recognize that he or she was not able to pronounce the “flower” in the same way that the teacher did and has to improve.

Be 5. In this step the student will be asked to read a long writings in order to see them to appear on the monitor the same way that they are in the written material which will be provided and the student should read from. If the student was able to do this accurately in a good number of times and pages. Then gradually, he or she will reach to a point which will be master in proper pronunciation and communications the way it is intended to.

B6. In this stage the computer system or the teacher will be able to listen to the voice or read the printed material which the student has read for the purpose of testing and examination. And if the student was able to pass the test, then they will pass the test and be considered as capable of speaking properly, and the student will receive their certificate to enjoy from its benefits.

Importance of this system is that it will be automatic and would not need a live teacher, since teaching and the commands can be prerecorded. Allowing this method to be used 24 hours and 7 days of a week in their own home environments, teaching places, coffee shops, in the schools, the libraries and similar. Therefore, it gives the chance to a large volume of the people and a mass to be able to use this method for advancement. This is what the applicant believes to be a great achievement in the progress of the mass.

Special Programs for Special People.

Applicant has the intention of producing a series of different teaching programs aimed for special groups: for example, a medical student, a nurse and a physician would need learning medical words, subjects and patient related materials. For example, medical names, pronunciations and similar commonly used in the medical field. However, obviously a lawyer would need using words which are commonly used by a lawyer which are significantly different than the terms used in medicine. Also, an engineer would need to learn more about the words, specifics and pronunciations which are commonly used in engineering. For this reason, the applicant has the intention of producing various programs for different students and persons so that it will facilitate their use of English.

Importantly, the teachings of this application may be also used for teaching other languages as well.

Dual Purpose Teachings and Special Importance of these Programs.

The applicant has the intention of making these programs in a way that the materials which are being thought to be a useful teaching material so that not only they will teach speaking English and writing it, will teach important issues in life and behaviors so that the reader to be able to benefit in 2 ways:
C1. The students will be able to learn English and proper pronunciations.
C2. The students will also learn different ideas, different ways of life, and thinking also being able to learn medical, social, political, and the different subjects in the process of learning English. And for example, the program's content to make the students able to pass certain examination, such as entrance examinations to the colleges and universities, or different jobs requirements. Thus, the plan of applicant is to make programs a dual purpose and with added benefits program for the students. Since all of these teachings and leanings will have something to do with the life of the people. And the applicant wants to do something that the lives of the people to improve, people to have a more prosperous and happier life. The new life has pushed people to work hard and harder to meet the ends, and for this purpose. The time for learning is also squeezed and a shorter time that people have to learn more. Thus a duel goal, teaching program such as the one this applicant introduces will be very beneficial.

Other Important Aspect of this Invention.

One very important aspect of this invention is that it will prepare the person to be able to use the universal voice recognition system for typing. As the time passes, it gets more and more clear that typing is difficult, time-consuming and it gets harder and harder with age, due to problems with the arthritis in the hands or there are neuromuscular systems of the hands which prevents or make it difficult to type. In these circumstances being able to talk to computer and have the materials printed on the screen will be very, very useful and invaluable. For this reason, one significant aspect of this invention is that this method prepares the students for using a common voice recognition system easily. This will be extremely valuable, since they would not need to spend significant time in teaching and modification of a voice recognition system for themselves alone. It should be known that that a person can modify his or her own voice recognition system, but in different places such as hospitals, offices and similar. There will be no personal voice recognition systems; therefore, the person should be able to use what the applicant calls again a universal voice recognition system which is already prepared for common use by people who are using the same pronunciations during their speeches. Or the modifications of the system will be very limited. Therefore, in practice instead of modifying the voice recognition system, the person will modify and change his or her voice to commonly used pronunciations which are fed into a universal voice recognition system. This will give the students the great advantage, which they will be able to use these systems with little or no modifications. This will be a great saving for the society in different places such as hospitals, big offices, and libraries and similar. The person simply tells words and see the words to appear in the computer.

Therefore, sometime in future there will be a true international language which will allow the humans to communicate with each other easily. And it's would be great.

The Using of this System for the Blinds or Partiality Blind People.

As we know there are people which for some reason God has limited some of their senses, however, the applicant believes that the mighty God. Amazingly has enhanced their other senses. For example, the applicant has seen a shopkeeper in his childhood in Zanjan, Iran who was totally blind, but he was able to touch the money and coins received then to sell the grocery. He sold the groceries and received the money and carefully palpated money between his fingers. He gets the idea of how much it worth and paid the remaining changes in papers and coins. He made his life for many years as the applicant remembers. The continuation of his small grocery shop meant to the applicant that was able to count the money he received and the changes. He gave reasonably accurate; otherwise he would have been bankrupt and stopped and has closed his shop. This what the applicant has seen in the childhood and he has wandered him how this man of about 50 years old was able to touch the paper money and coins, decide how much they were. Therefore, the applicant with his experience believes that that the blind people are capable of using their hearing very strongly and skillfully. More likely the applicant believes those blinds or at least some of them may be able to concentrate they are intelligence and pronounce the words even more accurately than the average. Thus for those this system will be very useful, since after a period of teaching, with help of special teachers. The blinds will be able to modify their voices and to talk properly and musically in order to attract their listeners. The this special computer systems with proper keyboards will then make them able to get certain jobs such as telephone operators and dispatchers and any jobs which only needs hearing and talking, since they can dispatch different messages to the computers or on the phones. For example, these people can be, able to function as of the operators on the phone system. They can hear and respond well and they are voices will be printed to. Making the life of many of such honorable, innocent citizens much more useful and allow them to earn their income and make their lives independently. They can be also be taught to be teachers of pronunciations for the rest of the world, for example the people from another countries can call them to chat with them, to improve their own pronunciations and the languages and pay them by credit cards.

Importantly, note that in these methods, the voice of the teacher which teaches the pronunciations is the same as the voice which is utilized to teach the universal voice recognition system and this is a very important and critical issue.

Use of this Program for Correcting the Behavioral Problems.

Applicant believes that the behavioral problems are part of major problems that people face in this age. And they are very difficult and at times impossible to be corrected. However, training may have a beneficial effect or at least some effect in modifying the Youth, who have behavioral problems. For this purpose this applicant proposes the following.

E. 1. Initially, the parents have to prepare a child to follow this teaching program. Using various incentives, such as buying a toy, giving prize, or allowing the student to do a thing they like.

E. 2. The student will be directed to read stories in English, and learn the right pronunciation.

E. 3. The student will receive the prize when he or she was able to pronounce read and print those in a written format, by using the universal voice-recognition system. For this, the student has to concentrate, to imitate and learn and obey the rules. If the student was able to read the teaching material which was provided and had it printed he or she will receive the prize.

E. 4. Importantly, however the teaching material will have many teaching points which will direct the student to behave properly. For example, it will teach that the having a bad temper is dangerous, it may cause various problems, physical involvements, injuries and even death, which is very true. For example, as it happened in Detroit, Mich., 2 friends were watching a game in the TV, they start an argument and during the argument one of the young TV watchers goes to his car brings a gun, shoots and kills his friend. Obviously, this is a very regrettable acts accident and no question that the person who committed this crime has regretted, but with no effect. The process has been an irreversible, it could not go back, and that killer was not left alone, he cannot be free to watch the TV again in his own home and has to be punished swiftly. This is story will be followed by asking the student to spell the followings.

Temper.

Bad temper.

Bad temper is dangerous.

Friend killed friend.

The killer was arrested by the police.

The killer is imprisoned.

The killer cannot have free life.

The killer cannot go to shopping's.

The killer will not be allowed to drive his car.

The killer cannot go to movie.

The killer cannot marry normally.

The killer has messed up his life badly.

The killer cannot have a normal life, even if he regrets his action.

For these reasons.

We should control our temper.

No matter how difficult that is.

Because.

If we control our temper.

We will not cause a problem due to bad temper.

We will not cause damage.

We will not end up with problem.

We will not end up in jail.

We can continue a happy normal life.

These words are also being used for teaching English. However, there is a very important intention in the background and it will teach the student why a bad behavior and bad temper is critically dangerous and has to be avoided. And, and these the stories will be repeated and repeated so that by repeating these teachings the chance is that we can improve our children's behavior. Which will be great and tremendous.

Second Story.

A young man was going to try an illegal drug heroin, which his friend offered. However, he was wise and clever therefore, before trying the heroine, he taught about the miserable life of his friend who was a drug addicts and was offering him the heroine. He noted that he simply did not have life, he had a miserable life, he was doing everything in order to get money and buy the drug for use. He noted that his friend, who was drug addict, was a spending tremendous amount of money for buying the drugs which was not making him happy but was making him sicker and sicker. He was kicked out from his own family, his own mother hated him, his own father hated him and all of his brothers and sisters hated him too. He did not have life and future. His friend started to be that way simply by one wrong move, which was trying the heroine free from his own friend initially. However, soon he was hooked up to it and could not get rid of. Therefore, the young man was clever to decide to kill himself, but not to be a drug addict. He broke his friendship with his addicted friend. He thought his addicted friend who was going to make him a drug addict was not a true friend, but a worse enemy. So he stopped trying the heroine and left. He prevented himself from being a drug addict. Then continued with his good friends, studied hard and ended up being a well-respected, well-loved Dr. in the society. He married a beautiful young girl he loved and had his own 1^{st} child and continued. Not only having good life and good family, but helped his patients tremendously. His addicted friend ended up in the Jail after stealing for having money to buy heroine, he got infected with HIV, injecting himself with dirty needles, and finally died from it. Strange enough, his father and mother and brothers and sisters turn out to be happy when he died because he had made their life miserable.

Young men.

Illegal drug.

Drug addict.

Miserable.

A Miserable life.

Thinking.

Thinking right

Taught.

Hate.

Hated.

Spend.

Spending.

Tremendous.

Kicking.

Kicked out.

Right.

Right move.

Wrong.

Wrong move.

Decided.

Decision.

Right away.

Wrong way.

Misery.

Happiness.

Please note that the applicant believes during the process of such practices the students will also notice that they are learning the language and pronouncing the language properly and this will have a positive effect in the their thinking which will be beneficial by itself.

Modification of the Microphones.

In order to allow the system to be utilized in a group, such as in libraries or classes there will be a need for microphones to prevent from voice of one person to move out to the next person sitting in a seat next to the 1^{st} one. For this reason, the microphones which are available now consisting from the headphone will be modified by using the unit shown in FIGS. 3, 4 and 5. This unit is like a facemask made from a soundproof material which has a resistant and durable outside pouch similar to the cover of the earmarks earmuffs, however it is modified to sit around the mouth, under the nose to prevent from transmission of voice of the person to the ears of the next person sitting close by. Thus this unit will be properly curved and covered to cover these areas comfortably. These units will have an open slit, as shown in FIG. 3 which allows the cable of the microphone between the head of the microphone and the base of the of the microphone to move through this is slit and stay reasonably secured by related means. Therefore by using this unit, the microphone will be placed inside the cover unit and its cable will stay outside. Thus the microphone will be isolated from the outside and the covering unit which has its own voice insulation will prevent from the voice to move out from the user to another. Therefore, this unit will allow in a classroom one student to talk to the computer and his or her voice not to be transmitted to the next person so that the system will be functional. Different views of this cover are shown in the figures.

1. A special language teaching system consisting of.
A. A computer system capable of analyzing a voice recognition system.
B. A voice recognition system designed with having a prerecorded language which can be heard by the student.
The voice recognition system to compare the voice of the student to the prerecorded language repeat and being capable to print a monitor the correct version if it matches the prerecorded language.
And an income direct version if the voice of the student does not match the prerecorded language.

2. A special language teaching system as set forth in claim 1 to be designed for teaching and English language.

2. A special language teaching system as set forth in claim 1 to also to have.
A booklet which will have the material which the teacher is a reading to be seen as written format in that booklet.

3. A special language teaching system as set force in claim 1. Also to have a teaching material to be a read in the native language of the student. So that the student will learn the teaching material in his or her own native language and be prepared. For the language for the teaching material to be a red by then English teacher.

4. A special language teaching system as set forth in claim 3. Also to have the teaching material be printed in the native language of the student. So that the student to be able to read the teaching material in his or native language and be prepared to hear the voice of the English teacher. To be able to associate what the English teacher says with what he or she is going to say.

5. A special language teaching system as set forth in claim 4. Also to have the teaching material be printed in the native language of the student. So that the student to be able to read the teaching material in his or native language and be prepared to hear the voice of the English teacher. To be able to associate what the English teacher says with what he or she is going to say.

6. A special language teaching system as set force in claim 1. Also to have a headset with the voice muffing cover around the microphone to prevent from the voice of user to spread around.

7. A special language teaching system as set force in claim 1. Also to have a headset with especially shaped voice muffing cover around the microphone to stand around the mouth and prevent from the voice of user to spread around.
